(19) United States
(12) Patent Application Publication
(10) Pub. No.: US 2002/0165975 A1
(43) Pub. Date: Nov. 7, 2002

(54) Dynamic mapping of communication protocols

(76) Inventor: Michael Abbott, Portola Valley, CA (US)

Correspondence Address: Richard A. Dunning, Jr., 325M Sharon Park Drive, Box 208, Menlo Park, CA, 94025, US

(21) Appl. No.: 09/850,219

(22) Filed: May 7, 2001

(51) Int. Cl. G06F 15/16

(52) U.S. Cl. 709/230

(57) ABSTRACT

A computer program product, apparatus, and method for facilitating communications among a group of partners including a first partner having a first communications protocol defining one or more first messages each including one or more first identifiers, and a second partner having a second communications protocol defining one or more second messages each including one or more second identifiers, the first and second protocols being different communications protocols. It includes identifying a first data dictionary for the first partner, the first data dictionary containing one or more entries, each entry including one of the first identifiers and one or more attributes of the one of the first identifiers; identifying a second data dictionary for the second partner, the second data dictionary containing one or more entries, each entry including one of the second identifiers and one or more attributes of the one of the second identifiers; selecting one of the entries in the first data dictionary; comparing the selected entry in the first data dictionary to each of the entries in the second data dictionary; selecting an entry in the second data dictionary based on comparing; and assigning the selected entry in the first data dictionary to the selected entry in the second data dictionary.

### BACKGROUND

The present invention relates generally to communication protocols, and particularly to communication protocols for electronic commerce.

The rise in demand for electronic commerce has prompted the development of a plethora of different electronic commerce systems. Unfortunately, each electronic commerce system employs a different protocol, thereby rendering it difficult or impossible for participants using different electronic commerce systems to communicate. Each protocol defines a different set of messages to be exchanged with participants in the marketplace defined by that protocol. Further, messages in different protocols may have different fields and formats. For example, one system may use the identifier “date” for the date field, while another system may use the identifier “datno,” or multiple identifiers “datno,” “monthno” and “yearno.” In addition, users of a single electronic commerce system may use the fields of a message in different ways. For example, an electronic data interchange (EDI) 850 message is a purchase order, but users can customize the EDI 850 so that it is no longer compatible across electronic commerce systems.

One conventional solution is to manually build a translator for each pair of electronic commerce systems. However, this process incurs great time and expense.

### SUMMARY

In general, in one aspect, the invention features a computer program product, apparatus, and method for facilitating communications among a group of partners including a first partner having a first communications protocol defining one or more first messages each including one or more first identifiers, and a second partner having a second communications protocol defining one or more second messages each including one or more second identifiers, the first and second protocols being different communications protocols. It includes identifying a first data dictionary for the first partner, the first data dictionary containing one or more entries, each entry including one of the first identifiers and one or more attributes of the one of the first identifiers; identifying a second data dictionary for the second partner, the second data dictionary containing one or more entries, each entry including one of the second identifiers and one or more attributes of the one of the second identifiers; selecting one of the entries in the first data dictionary; comparing the selected entry in the first data dictionary to each of the entries in the second data dictionary; selecting an entry in the second data dictionary based on comparing; and assigning the selected entry in the first data dictionary to the selected entry in the second data dictionary.

Particular implementations can include one or more of the following features. The communications protocol is an electronic commerce protocol. An attribute in each entry describes the relationship between the identifier in the entry and other identifiers in the data dictionary containing that entry. Comparing includes assigning a normalized term to the selected entry in the first data dictionary when no normalized term has been previously assigned to the selected entry in the first data dictionary; and assigning includes assigning the normalized term to the entry selected in the second data dictionary.

It can include creating a mapping file describing the assignments between the entries in the first data dictionary and the entries in the second data dictionary; and sending the mapping file to the first and second partners.

It can include receiving a message from one of the first and second partners; and selectively sending the message to the other of the first and second partners based on the terms of a partner agreement, the terms describing the conditions under which messages may be exchanged between the first and second partners.

It can include receiving a message from one of the first and second partners; and translating the message from the protocol of the one of the first and second partners to the protocol of the other of the of the first and second partners based on the assignments between the entries in the first data dictionary and the entries in the second data dictionary; and sending the translated message to the other of the first and second partners.

It can include selectively sending the message based on the terms of a partner agreement, the terms describing the conditions under which messages may be exchanged between the first and second partners.

It can include receiving a message from one of the first and second partners, the message requiring concatenation with a further message to produce the equivalent of a message for the other of the first and second partners; storing the message until the further message is received; concatenating the message and the further message; and sending the concatenated message to the other of the first and second partners.

Advantages that can be seen in implementations of the invention include one or more of the following. Communications protocols such as electronic commerce protocols are dynamically mapped, thereby facilitating communications among partners having different communications protocols. Partner agreements such as trading partner agreements are enforced.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an implementation where trading partner engine (TPE) clients and translators are located within trading partners (TP).

FIG. 2 is a block diagram of an implementation where TPE clients are located within the TPs and a translator is located within the TPE.

FIG. 3 is a block diagram of an implementation where trading partner engine (TPE) clients and translators are located within marketplace servers.

FIG. 4 is a block diagram of an implementation where TPE clients are located within marketplace servers and a translator is located within the TPE.

FIG. 5 is a flow diagram depicting an example communication between TPs having different electronic commerce protocols according to the implementation of FIG. 1 where message translation occurs at the TP sending the message.

FIG. 6 is a flow diagram depicting an example communication between TPs having different electronic commerce protocols according to the implementation of FIG. 1 where message translation occurs at both TPs using a normalized message.

FIG. 7 is a flow diagram depicting an example communication between TPs having different electronic commerce protocols according to the implementation of FIG. 2.

FIG. 8 is a flowchart depicting an example interaction between a TP and the TPE according to one implementation.

FIGS. 9A and 9B are a flowchart depicting an example operation of the TPE in generating a mapping file according to one implementation.

Like reference symbols in the various drawings indicate like elements.

### DETAILED DESCRIPTION

In one implementation, a trading partner engine (TPE) facilitates electronic commerce among trading partners (TP) that have similar or different protocols. A TPE client provides an interface to the TPE. A TPE client can be located within a TP or within a marketplace server that serves the TP.

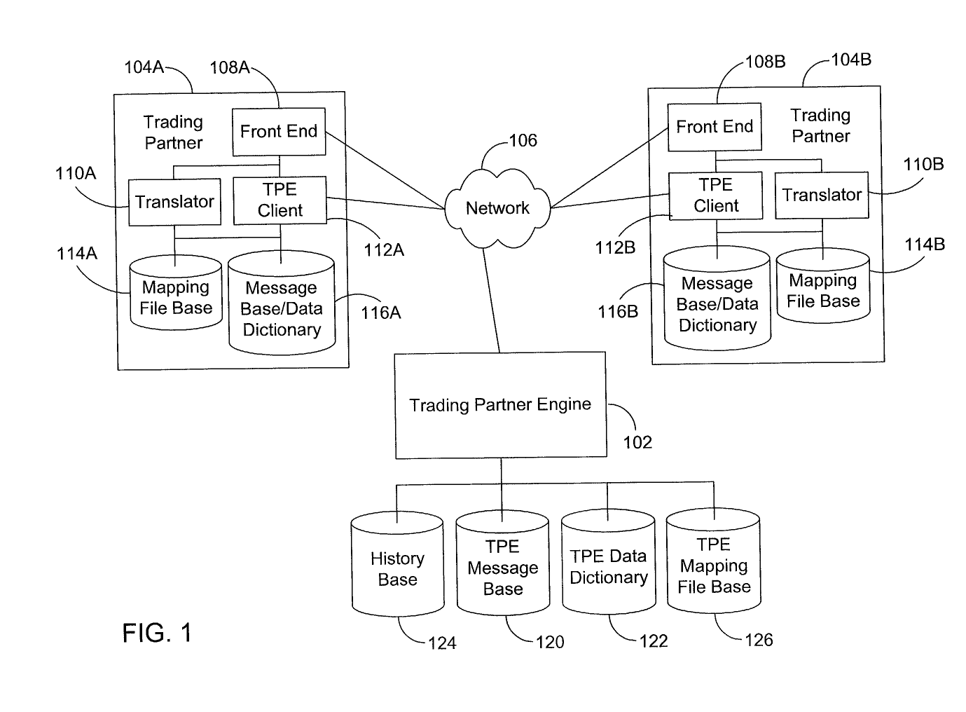

As shown in FIG. 1, in one implementation, TP clients are located within the TPs. Two TPs 104A, 104B are shown. TP 104A includes a front end 108A, a translator 110A, a TPE client 112A, a mapping file base 114A, and a message base/data dictionary 116A. TP 104B includes a front end 108B, a translator 110B, a TPE client 112B, a mapping file base 114B, and a message base/data dictionary 116B. Front end 108, translator 110, and TPE client 112 can include software modules configured to execute on conventional computer systems. Message base/data dictionary 114 can include conventional databases. Each TP 104 uses its front end 108 to communicate with other TPs 104 over a network 106, such as the Internet. This communication includes populating and exchanging messages stored in message base/data dictionary 114.

Each TPE client 112 communicates with a TPE 102, also using a network 106, such as the Internet. This communication can include uploading data dictionaries and message bases from TPs to the TPE, and downloading mapping files from the TPE to TPs. The TPE may store these message bases and data dictionaries in a TPE message base 120 and a TPE data dictionary 122, respectively. The TPE may also record the results of certain TPE operations, as discussed in detail below, in a history base 124. TPE 102 also generates mapping files, as described below. TPE 102 may store these mapping files in a TPE mapping file base 126. TPE 102 can include software modules configured to execute on conventional computer systems. TPE message base 120, TPE data dictionary 122, history base 124 and TPE mapping file base 126 can include conventional databases. In the implementation of FIG. 1, translator 110 performs message translation at the TP using mapping file base 114, as described in detail below.

The translated messages may be exchanged through the TPE, or directly between the TPs. In one implementation, all messages must be sent through the TPE. The TPE receives each message and selectively sends the message to the recipient TP based on the terms of a trading partner agreement. The terms of the trading partner agreement describe the conditions under which messages may be exchanged between the TPs.

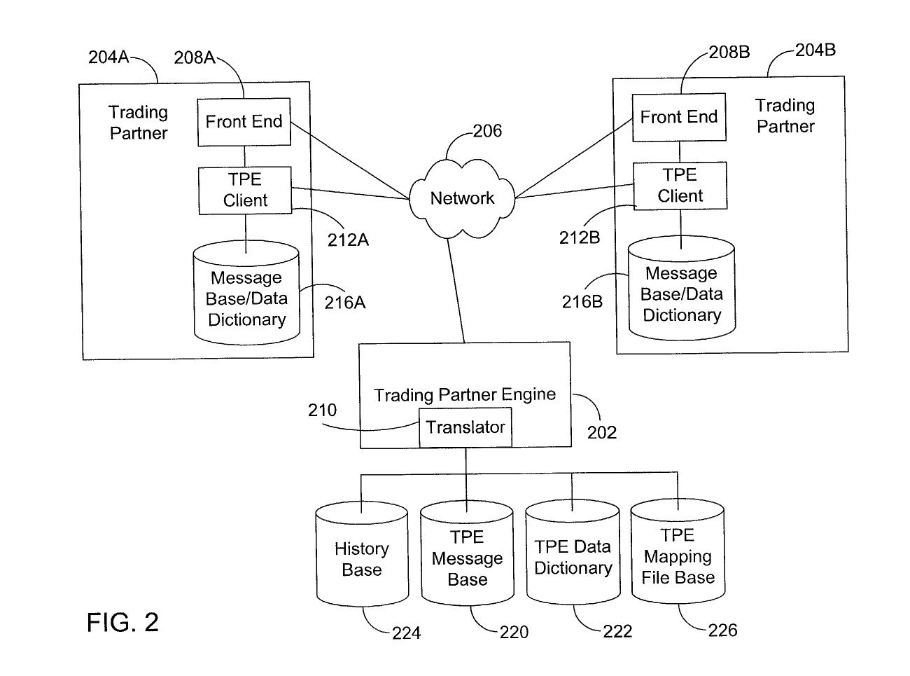

In another implementation, shown in FIG. 2, messages are exchanged through the TPE, where message translation is performed. Two TPs 204A, 204B are shown. TP 204A includes a front end 208A, a TPE client 212A, and a message base/data dictionary 216A. TP 204B includes a front end 208B, a TPE client 212B, and a message base/data dictionary 216B. Front end 208 and TPE client 212 can include software modules configured to execute on conventional computer systems. Message base/data dictionary 214 can include a conventional database. Each TP 204 uses its front end 208 to communicate with other TPs 204 over a network 206, such as the Internet. This communication includes populating and exchanging messages stored in message base/data dictionary 214.

Each TPE client 212 communicates with a TPE 202, also using a network 206, such as the Internet. This communication can include exchanging messages with TPs. This communication can also include uploading data dictionaries and message bases from TPs to the TPE. The TPE may store these message bases and data dictionaries in a TPE message base 220 and a TPE data dictionary 222, respectively. The TPE may also record the results of certain TPE operations in a history base 224. TPE 202 also generates mapping files, as described below. TPE 202 may store these mapping files in a TPE mapping file base 226. TPE 202 can include software modules configured to execute on conventional computer systems. TPE message base 220, TPE data dictionary 222, history base 224 and TPE mapping file base 226 can include conventional databases. TPE 202 receives messages from TPs, translates them using translator 210, and sends them to other TPs, as described below.

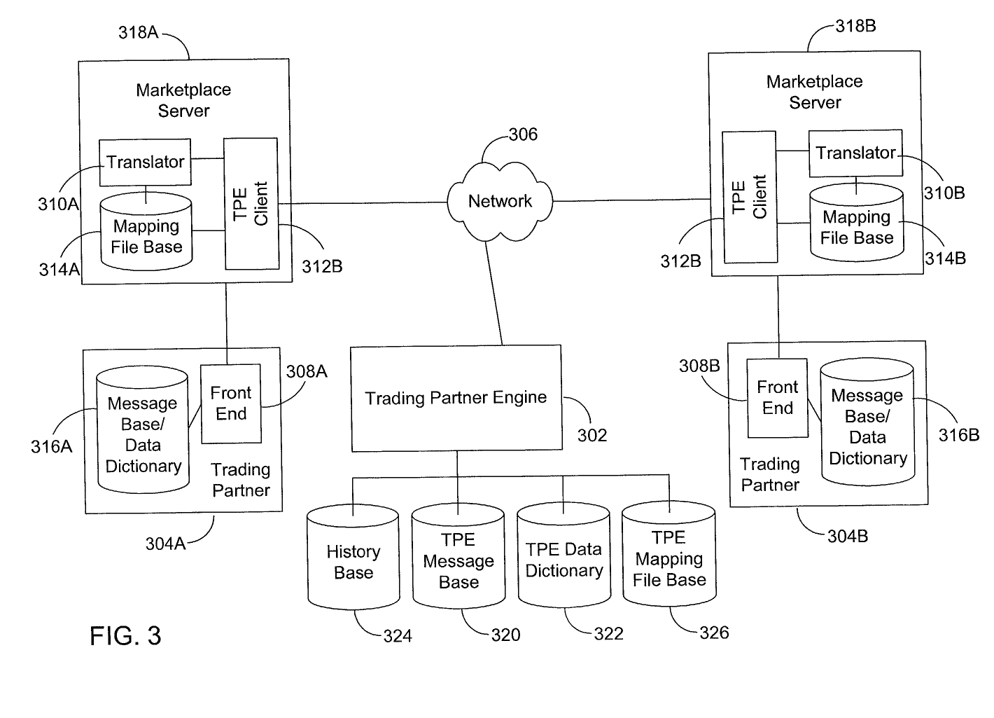

As shown in FIG. 3, in another implementation, TP clients are located within marketplace servers that serve the TPs. Two TPs 304A, 304B are shown. TP 304A includes a front end 308A and a message base/data dictionary 316A. TP 304A communicates with a marketplace server 318A that includes a translator 310A, a TPE client 312A, and a mapping file base 314A. TP 304B includes a front end 308B and a message base/data dictionary 316B. TP 304B communicates with a marketplace server 318B that includes a translator 310B, a TPE client 312B, and a mapping file base 314B. Front end 308, translator 310, and TPE client 312 can include software modules configured to execute on conventional computer systems. Message base/data dictionary 316 and mapping file base 314 can include conventional databases. Each TP 304 uses its front end 308 to communicate with marketplace server 318, which communicates with other TPs and marketplace servers over a network 306, such as the Internet. This communication includes exchanging messages using message base/data dictionary 316.

Each TPE client 312 communicates with a TPE 302 using a network 306, such as the Internet. This communication can include uploading data dictionaries and message bases from TPs and marketplace servers, and downloading mapping files to marketplace servers. The TPE may store these message bases and data dictionaries in a TPE message base 320 and a TPE data dictionary 322, respectively. The TPE may also record the results of certain TPE operations, as discussed in detail below, in a history base 324. TPE 302 also generates mapping files, as described below. TPE 302 may store these mapping files in a TPE mapping file base 326. TPE 302 can include software modules configured to execute on conventional computer systems. TPE message base 320, TPE data dictionary 322, history base 324 and TPE mapping file base 326 can include conventional databases.

In the implementation of FIG. 3, translator 310 performs message translation at the marketplace server using mapping file base 314. The translated messages may be exchanged through the TPE, or directly between marketplace servers.

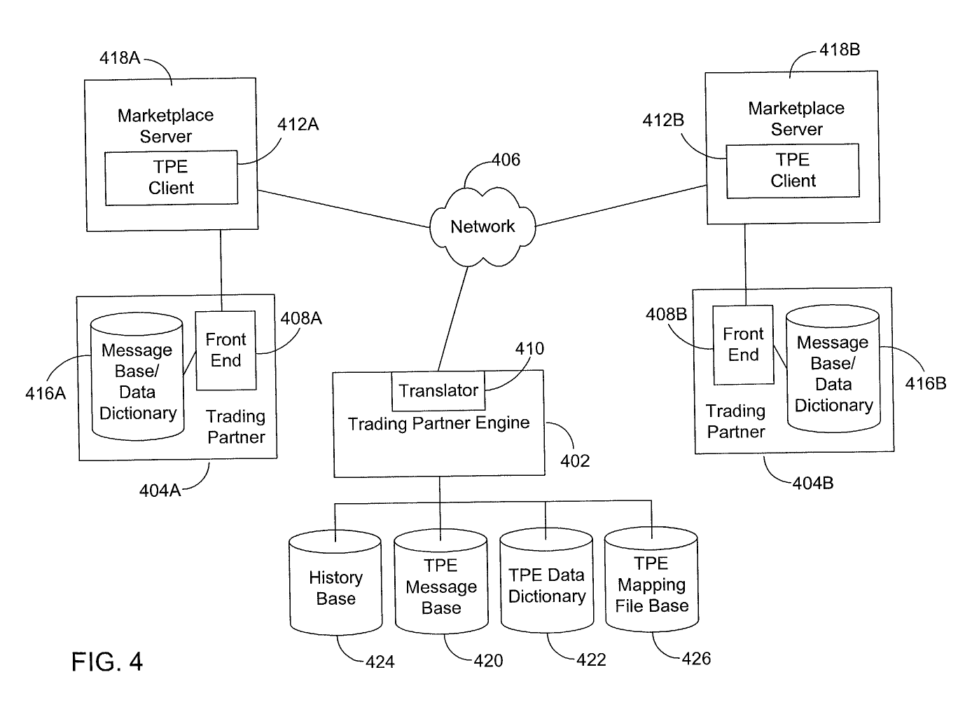

In another implementation, shown in FIG. 4, messages are exchanged through the TPE, where message translation is performed. Two TPs 404A, 404B are shown. TP 404A includes a front end 408A and a message base/data dictionary 416A. TP 404A communicates with a marketplace server 418A that includes a TPE client 412A. TP 404A includes a front end 408B and a message base/data dictionary 416B. TP 404B communicates with a marketplace server 418B that includes a TPE client 412B. Front end 408 and TPE client 412 can include software modules configured to execute on conventional computer systems. Message base/data dictionary 416 can include a conventional database. Each TP 404 uses its front end 408 to communicate with marketplace server 418, which communicates with other TPs and marketplace servers over a network 406, such as the Internet. This communication includes exchanging messages using message base/data dictionary 416.

Each TPE client 412 communicates with a TPE 402 using a network 406, such as the Internet. This communication can include uploading data dictionaries and message bases from TPs and marketplace servers, and downloading mapping files to marketplace servers. The TPE may store these message bases and data dictionaries in a TPE message base 420 and a TPE data dictionary 422, respectively. The TPE may also record the results of certain TPE operations, as discussed in detail below, in a history base 424. TPE 402 also generates mapping files, as described below. TPE 402 may store these mapping files in a TPE mapping file base 426. TPE 402 can include software modules configured to execute on conventional computer systems. TPE message base 420, TPE data dictionary 422, history base 424 and TPE mapping file base 426 can include conventional databases. TPE 402 receives messages from TPs, translates them using translator 410, and sends them to other TPs, as described below.

For clarity, example operations of the invention are described with reference to the implementations of FIGS. 1 and 2. After reading this description, the operation of the implementations of FIGS. 3 and 4 will be apparent to one skilled in the relevant arts.

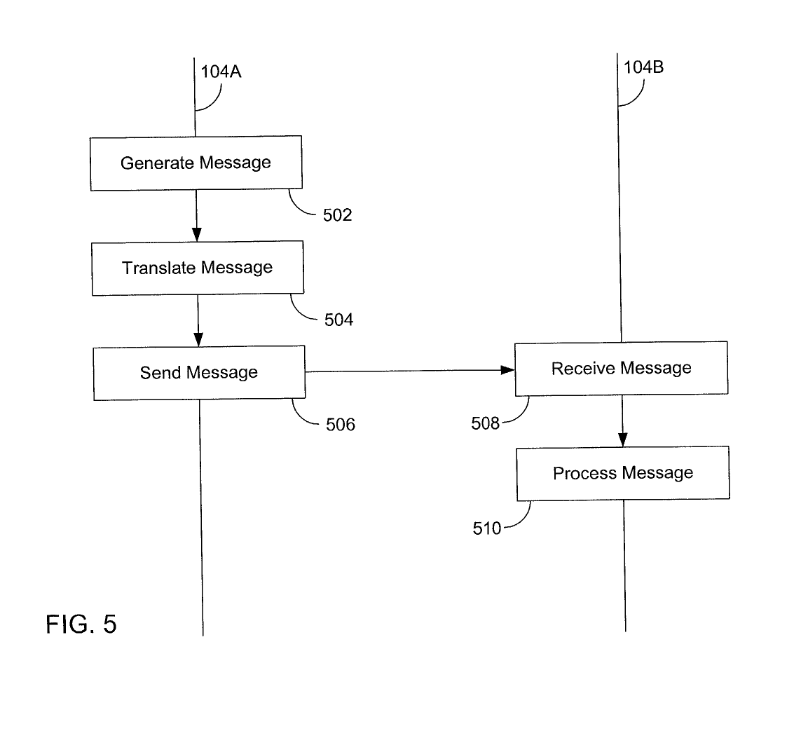

FIG. 5 is a flow diagram depicting an example communication between TPs having different electronic commerce protocols according to the implementation of FIG. 1. It is assumed that TP 104A and TP 104B use different electronic commerce protocols. TP 104A generates a message intended for TP 104B (step 502). Because TP 104B uses a different electronic commerce protocol, TP 104A translates the message before sending it (step 504) from the protocol of TP 104A to one or more messages in the protocol of TP 104B. Translator 110A translates the message by translating each identifier in the message to one or more identifiers specified by the protocol of TP 104B.

The mapping file base 114 for a TP 104 includes one or more mapping files. Each mapping file for a TP includes information sufficient to translate any message specified by the protocol of that TP to the protocol of one or more other TPs. Each entry in a mapping file for a TP includes an identifier used in a message in the protocol of that TP, and at least one equivalent identifier in the protocol of at least one other TP.

For example, TP 104A wants to send a purchase order to TP 104B. However, TPs 104A and 104B use different protocols. The purchase order message for TP 104A uses the identifier “date” for the date field, while TP 104B uses the identifier “datno” for the date field. Mapping file base 114A includes a mapping file for TP 104B that includes an entry for the identifier “date” in the protocol of TP 104A that specifies the identifier “datno” as the equivalent identifier in the protocol of TP 104B. Translator 110A in TP 104A translates the message by comparing each identifier in the message to the mapping file for TP 104B to determine whether an entry for that identifier exists. If an entry for the identifier exists, translator 110A replaces the identifier in the protocol of TP 104A in the message with the identifier in the protocol of TP 104B listed in that entry. When all of the identifiers have been checked, and if necessary, replaced, the message has been translated to the protocol of TP 104B.

TP 104B then sends the translated message to TP 104B (step 506). TP 104B receives the translated message (step 508). In some cases, the translated message requires concatenation with one or more other messages to produce the equivalent of a message for TP 104B. In this case, TP 104B stores the translated message until the required message is received, and then concatenates the two messages. TP 104B then processes the message according to well-known methods (step 510).

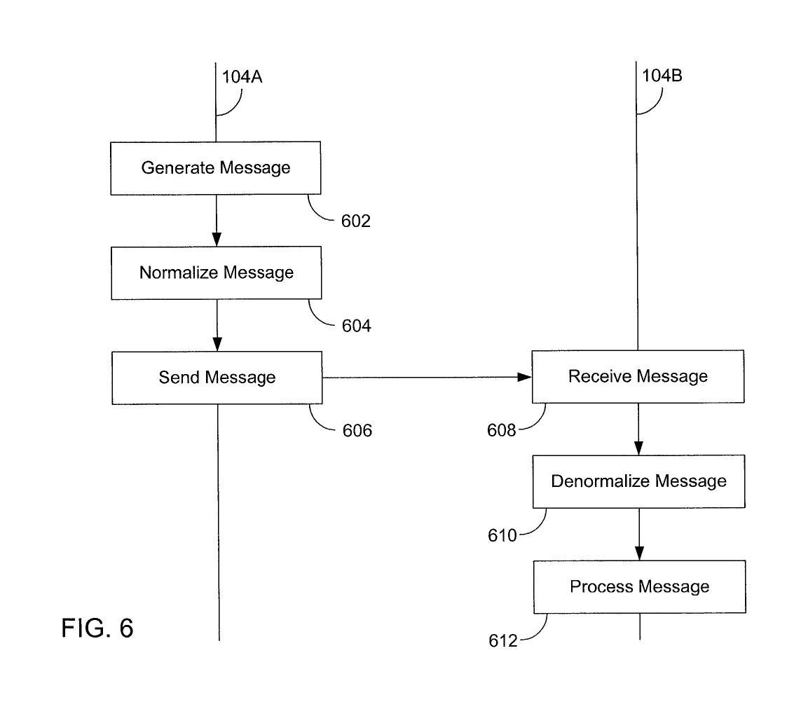

In the example of FIG. 5, message translation is performed at the TP sending the message. In another implementation, message translation is performed at the TP receiving the message. In still another implementation, a normalized message protocol is used for the exchange of messages. According to this implementation, the sending TP translates the message from its protocol to the normalized message protocol (that is, the sending TP “normalizes” the message), and the receiving TP translates the message from the normalized message protocol to its protocol (that is, the receiving TP “denormalizes” the message). This implementation is described with reference to FIG. 6.

FIG. 6 is a flow diagram depicting an example communication between TPs having different electronic commerce protocols according to the implementation of FIG. 1. It is assumed that TP 104A and TP 104B use different electronic commerce protocols. TP 104A generates a message intended for TP 104B (step 602). Because TP 104B uses a different electronic commerce protocol, TP 104A normalizes the message before sending it (step 604). Translator 110A normalizes the message by translating each identifier in the message to a normalized term (nterm).

According to this implementation, each mapping file for a TP includes information sufficient to translate any message specified by the protocol of that TP to the normalized message protocol. Each entry in a mapping file for a TP includes an identifier used in a message in the protocol of that TP, and at least one equivalent nterm in the normalized message protocol.

TP 104A sends the normalized message to TP 104B (step 606). TP 104B receives the normalized message (step 608). TP 104B denormalizes the normalized message (step 610), thereby producing a message in the protocol of TP 104B. Translator 110B denormalizes the message by translating each nterm in the message to an identifier in the protocol of TP 104B using a mapping file similar to that used to normalize the message.

In some cases, the received message requires concatenation with one or more other messages to produce the equivalent of a message for TP 104B. In this case, TP 104B stores the received message until the required message is received, and then concatenates the two messages. Concatenation can be performed either before or after denormalization. TP 104B then processes the message according to well-known methods (step 612).

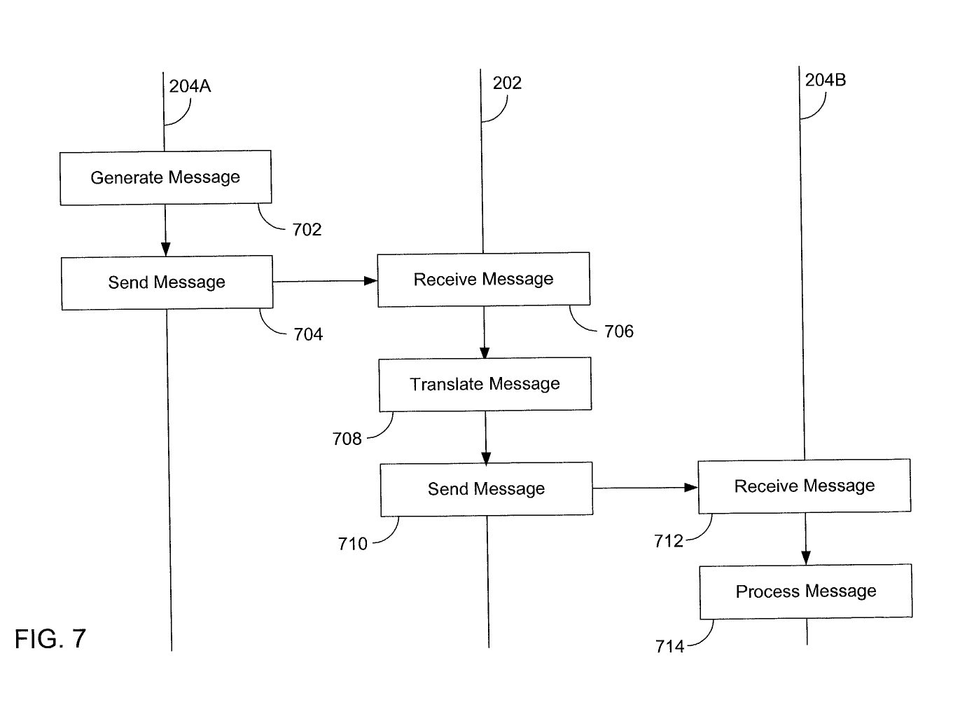

FIG. 7 is a flow diagram depicting an example communication between TPs having different electronic commerce protocols according to the implementation of FIG. 2. It is assumed that TP 204A and TP 204B use different electronic commerce protocols. TP 204A generates a message intended for TP 204B (step 702). TP 204B then sends the message to TPE 202 (step 704).

TPE 202 receives the message (step 706). Because TPs 204A and 204B use different electronic commerce protocols, TPE 202 translates the message (step 708) from the protocol of TP 204A to one or more messages in the protocol of TP 204B. Translator 210 translates the message by translating each identifier in the message to one or more identifiers specified by the protocol of TP 204B using TPE mapping file base 226. This translation process is similar to that described above with reference to FIG. 5

In some cases, the received message requires concatenation with one or more other messages to produce the equivalent of a message for TP 204B. In this case, TPE 202 stores the received message until the required message is received, and then concatenates the two messages. Concatenation can be performed either before or after translation.

TPE 202 sends the translated message to TP 204B (step 710). TP 204B receives the translated message (step 712). TP 204B then processes the message according to well-known methods (step 714).

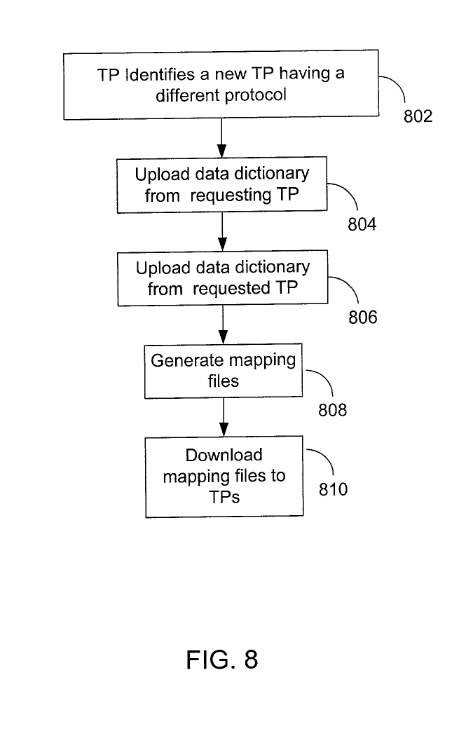

FIG. 8 is a flowchart depicting an example interaction between a TP and the TPE according to one implementation. The TP first indicates a desire to trade with a TP having a different protocol, and with which the TP has not traded before (step 802). For clarity, the TP that indicates a desire to trade is referred to herein as the “requesting TP,” and the TP indicated by the requesting TP is referred to herein as the “requested TP.”

The requesting TP uploads its data dictionary (step 804). The requested TP also uploads its data dictionary (step 806). Such data dictionaries are well-known in the relevant arts. A data dictionary includes an entry for each identifier in its electronic commerce protocol. The data dictionary entries can be in a generic format such as extensible markup language (XML). Each entry includes the identifier and attributes of the identifier. Attributes of the identifier can include information such as the identity of the TP, the protocol of the TP, message identity, format of the identifier, length of the identifier, and the location of the identifier in a hierarchical structure of the message (such as pointers to the parent and child identifiers of the identifier.)

Each message includes one or more identifiers in a particular structure. The structure includes the relationships among the identifiers in the message. For example, the message may have a hierarchical structure. The structure for an identifier then can include the hierarchical relationship of the identifier to other identifiers, such as parent identifiers and child identifiers.

The TPE then generates a mapping file for one or both of the TPs (step 808), as described below. The TPE then downloads each mapping file to the appropriate TP (step 810).

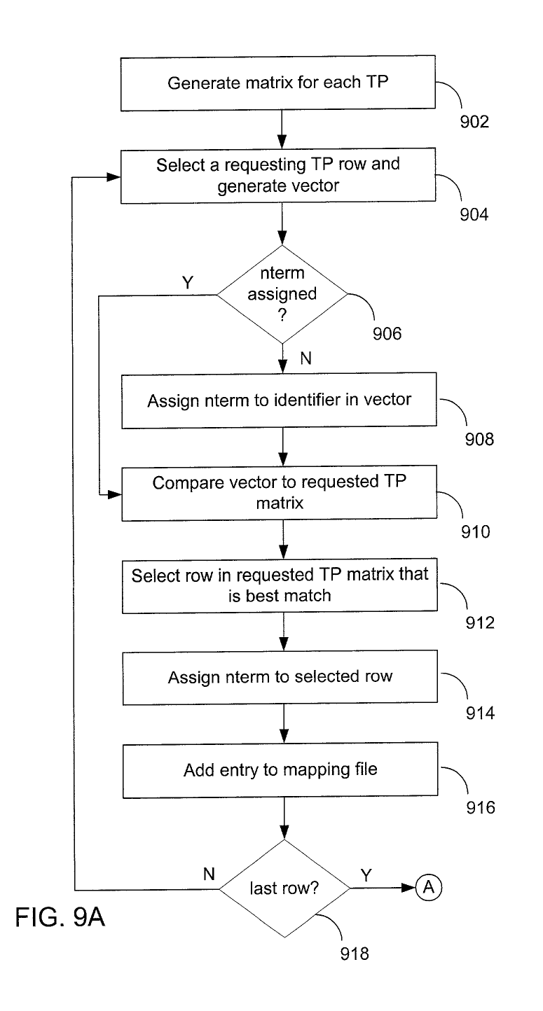

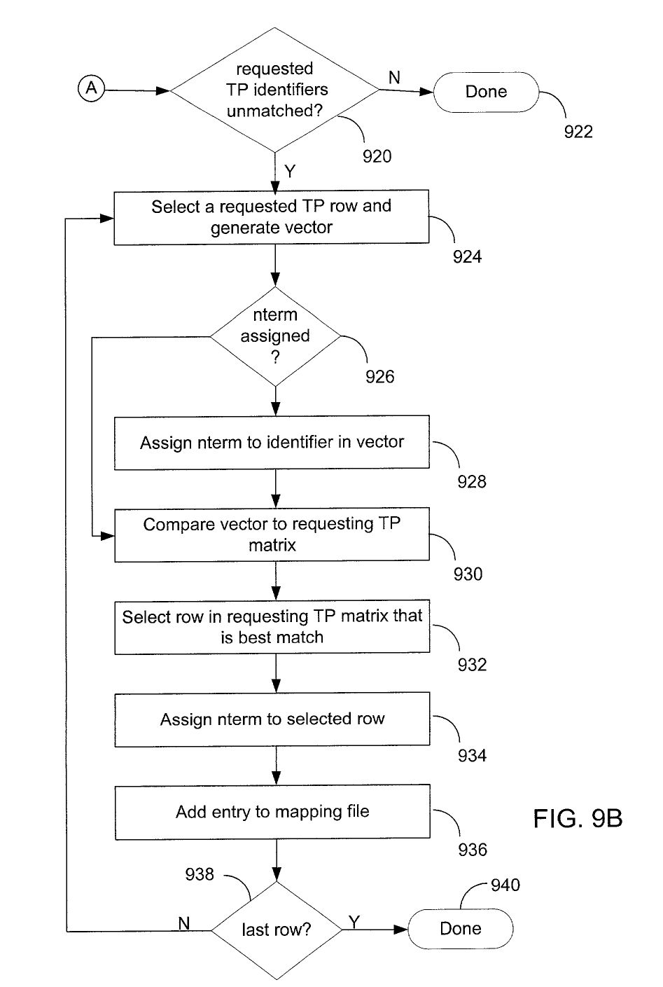

FIG. 9 is a flowchart depicting an example operation of the TPE in generating a mapping file according to one implementation. The TPE first generates a matrix for each TP based on the TP's data dictionaries (step 902). The matrix for a TP resembles its data dictionary, with a row for each entry. Each row includes an identifier, the attributes for the identifier, and an nterm if one has been assigned to the identifier.

The TPE first generates a mapping file from the point of view of the requesting TP. The TPE selects a row from the requesting TP matrix and creates a vector using that row (step 904). The TPE then determines whether an nterm has been assigned to the identifier in the vector (step 906). If not, then the TPE assigns an nterm to the identifier (step 908).

The TPE then compares the vector to the requested TP matrix (step 910). Based on this comparison, the TPE selects the row in the requested TP matrix that is the best match to the requesting TP vector (step 912). This matching operation can be conducted according to well-known methods. For example, the matching operation can employ either a simple binary match or a fuzzy match. In either case, the matching can employ a simple brute force approach, a heuristic approach, other methods, or a combination of these methods.

Under the binary matching approach, the TPE compares the names, attributes and structure associated with the identifiers for the TPs. Any match of names, attributes or structure increases a score for the overall identifier match. The score is used to select the best match.

Under the heuristic approach, the results of previous matches involving other TPs are used in the matching operation, such as using scores from previous matches. For example, associative mapping can be used. That is, if an identifier for a TP A has previously been matched to an identifier for a TP B, and the identifier for TP B has previously been matched to an identifier for a TP C, then the score for a match between the identifier for TP A and the identifier for TP C is increased.

The TPE then assigns the nterm from the requesting TP vector to the requested TP row that was selected as the best match (step 914). The TPE then adds an entry to the mapping file that contains the identifier from the requesting TP vector, the identifier from the selected requested TP row, and the nterm assigned to both identifiers (step 916).

This process is repeated for each of the requesting TP identifiers (step 918).

The TPE then determines whether any requested TP identifiers remain unmatched (step 920). This can happen in two cases. First, there may be requesting TP identifiers that are not yet paired with requested TP identifiers. For example, the requested TP may use a single identifier “date” for the date while the requesting TP uses three identifiers “datno,” “monthno” and “yearno.” At this point the TPE has matched “date” with “datno” so that “monthno” and “yearno” remain unmatched.

Second, the message flow is to be bi-directional. There may be requested TP identifiers that have not been matched to requesting TP identifiers. For example, the requesting TP may use one identifier for the zip code “zipcod” while the requested TP uses two identifiers “zip” and “zip+4.” At this point the TPE has matched “zipcod” with “zip” so we still have “zip+4” to remain unmatched.

If no requested TP identifiers remain unmatched, the process is done (step 922). However, if any requested TP identifiers remain unmatched, then the TPE continues to generate the mapping file, now from the point of view of the requested TP. The TPE selects a row from the requested TP matrix and creates a vector using that row (step 924). The TPE then determines whether an nterm has been assigned to the identifier in the vector (step 926). If not, then the TPE assigns an nterm to the identifier (step 928).

The TPE then compares the vector to the requesting TP matrix (step 930). Based on this comparison, the TPE selects the row in the requesting TP matrix that is the best match to the requested TP vector (step 932). This matching operation can be conducted as described above.

The TPE then assigns the nterm from the requested TP vector to the requesting TP row that was selected as the best match (step 934). The TPE then adds an entry to the mapping file that contains the identifier from the requested TP vector, the identifier from the selected requesting TP row, and the nterm assigned to both identifiers (step 936).

This process is repeated for each of the requested TP identifiers (step 938).

The TPE then reviews the mapping file to detect any one-to-many relationships among identifiers. If any one-to-many relationships are detected, the TPE assigns an appropriate automatic parsing rule to handle the relationship. If no suitable automatic parsing rule exists, the TPE flags the relationship for manual intervention to create an automatic parsing rule. The rule is added to the mapping file.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of embodiments of the invention have been described. Nevertheless, it will be understood that various modifications may be made without departing from the spirit and scope of the invention. For example, implementations of the present invention are useful for translating message protocols other than those used for electronic commerce. In such an implementation, the trading partners are referred to simply as “partners,” and the trading partner engine is referred to simply as a “partner engine.” Accordingly, other embodiments are within the scope of the following claims.

What is claimed is:

1. A computer program product, tangibly stored on a computer-readable medium, for facilitating communications among a group of partners including a first partner having a first communications protocol defining one or more first messages each including one or more first identifiers, and a second partner having a second communications protocol defining one or more second messages each including one or more second identifiers, the first and second protocols being different communications protocols, the product comprising instructions operable to cause a programmable processor to:
identify a first data dictionary for the first partner, the first data dictionary containing one or more entries, each entry including one of the first identifiers and one or more attributes of the one of the first identifiers;
identify a second data dictionary for the second partner, the second data dictionary containing one or more entries, each entry including one of the second identifiers and one or more attributes of the one of the second identifiers;
select one of the entries in the first data dictionary;
compare the selected entry in the first data dictionary to each of the entries in the second data dictionary;
select an entry in the second data dictionary based on comparing; and
assign the selected entry in the first data dictionary to the selected entry in the second data dictionary.

2. The product of claim 1, wherein:
the communications protocol is an electronic commerce protocol.

3. The product of claim 2, wherein:
an attribute in each entry describes the relationship between the identifier in the entry and other identifiers in the data dictionary containing that entry.

4. The product of claim 3, wherein:
instructions operable to cause a programmable processor to compare include instructions operable to cause a programmable processor to assign a normalized term to the selected entry in the first data dictionary when no normalized term has been previously assigned to the selected entry in the first data dictionary; and
instructions operable to cause a programmable processor to assign the selected entry include instructions operable to cause a programmable processor to assign the normalized term to the entry selected in the second data dictionary.

5. The product of claim 4, further comprising instructions operable to cause a programmable processor to:
create a mapping file describing the assignments between the entries in the first data dictionary and the entries in the second data dictionary; and
send the mapping file to the first and second partners.

6. The product of claim 5, further comprising instructions operable to cause a programmable processor to:
receive a message from one of the first and second partners; and
selectively send the message to the other of the first and second partners based on the terms of a partner agreement, the terms describing the conditions under which messages may be exchanged between the first and second partners.

7. The product of claim 5, further comprising instructions operable to cause a programmable processor to:
receive a message from one of the first and second partners, the message requiring concatenation with a further message to produce the equivalent of a message for the other of the first and second partners;
store the message until the further message is received;
concatenate the message and the further message; and
send the concatenated message to the other of the first and second partners.

8. The product of claim 4, further comprising instructions operable to cause a programmable processor to:
receive a message from one of the first and second partners;
translate the message from the protocol of the one of the first and second partners to the protocol of the other of the of the first and second partners based on the assignments between the entries in the first data dictionary and the entries in the second data dictionary; and
send the translated message to the other of the first and second partners.

9. The product of claim 8, wherein instructions operable to cause a programmable processor to send comprise instructions operable to cause a programmable processor to:
selectively send the message based on the terms of a partner agreement, the terms describing the conditions under which messages may be exchanged between the first and second partners.

10. The product of claim 4, further comprising instructions operable to cause a programmable processor to:
receive a message from one of the first and second partners, the message requiring concatenation with a further message to produce the equivalent of a message for the other of the first and second partners;
store the message until the further message is received;
concatenate the message and the further message; and
send the concatenated message to the other of the first and second partners.

11. An apparatus for facilitating communications among a group of partners including a first partner having a first communications protocol defining one or more first messages each including one or more first identifiers, and a second partner having a second communications protocol defining one or more second messages each including one or more second identifiers, the first and second protocols being different communications protocols, the apparatus comprising:
means for identifying a first data dictionary for the first partner, the first data dictionary containing one or more entries, each entry including one of the first identifiers and one or more attributes of the one of the first identifiers;
means for identifying a second data dictionary for the second partner, the second data dictionary containing one or more entries, each entry including one of the second identifiers and one or more attributes of the one of the second identifiers;
means for selecting one of the entries in the first data dictionary;
means for comparing the selected entry in the first data dictionary to each of the entries in the second data dictionary;
means for selecting an entry in the second data dictionary based on comparing; and
means for assigning the selected entry in the first data dictionary to the selected entry in the second data dictionary.

12. The apparatus of claim 11, wherein:
the communications protocol is an electronic commerce protocol.

13. The apparatus of claim 12, wherein:
an attribute in each entry describes the relationship between the identifier in the entry and other identifiers in the data dictionary containing that entry.

14. The apparatus of claim 13, wherein:
means for comparing includes means for assigning a normalized term to the selected entry in the first data dictionary when no normalized term has been previously assigned to the selected entry in the first data dictionary; and
means for assigning includes means for assigning the normalized term to the entry selected in the second data dictionary.

15. The apparatus of claim 14, further comprising:
means for creating a mapping file describing the assignments between the entries in the first data dictionary and the entries in the second data dictionary; and
means for sending the mapping file to the first and second partners.

16. The apparatus of claim 15, further comprising:
means for receiving a message from one of the first and second partners; and
means for selectively sending the message to the other of the first and second partners based on the terms of a partner agreement, the terms describing the conditions under which messages may be exchanged between the first and second partners.

17. The apparatus of claim 15, further comprising:
means for receiving a message from one of the first and second partners, the message requiring concatenation with a further message to produce the equivalent of a message for the other of the first and second partners;
means for storing the message until the further message is received;
means for concatenating the message and the further message; and
means for sending the concatenated message to the other of the first and second partners.

18. The apparatus of claim 14, further comprising:
means for receiving a message from one of the first and second partners;
means for translating the message from the protocol of the one of the first and second partners to the protocol of the other of the of the first and second partners based on the assignments between the entries in the first data dictionary and the entries in the second data dictionary; and
means for sending the translated message to the other of the first and second partners.

19. The apparatus of claim 18, wherein means for sending comprises:
means for selectively sending the message based on the terms of a partner agreement, the terms describing the conditions under which messages may be exchanged between the first and second partners.

20. The apparatus of claim 14, further comprising:
means for receiving a message from one of the first and second partners, the message requiring concatenation with a further message to produce the equivalent of a message for the other of the first and second partners;
means for storing the message until the further message is received;
means for concatenating the message and the further message; and
means for sending the concatenated message to the other of the first and second partners.

21. A computer-implemented method for facilitating communications among a group of partners including a first partner having a first communications protocol defining one or more first messages each including one or more first identifiers, and a second partner having a second communications protocol defining one or more second messages each including one or more second identifiers, the first and second protocols being different communications protocols, the method comprising:
identifying a first data dictionary for the first partner, the first data dictionary containing one or more entries, each entry including one of the first identifiers and one or more attributes of the one of the first identifiers;
identifying a second data dictionary for the second partner, the second data dictionary containing one or more entries, each entry including one of the second identifiers and one or more attributes of the one of the second identifiers;
selecting one of the entries in the first data dictionary;
comparing the selected entry in the first data dictionary to each of the entries in the second data dictionary;
selecting an entry in the second data dictionary based on comparing; and
assigning the selected entry in the first data dictionary to the selected entry in the second data dictionary.

22. The method of claim 21, wherein:
the communications protocol is an electronic commerce protocol.

23. The method of claim 22, wherein:
an attribute in each entry describes the relationship between the identifier in the entry and other identifiers in the data dictionary containing that entry.

24. The method of claim 23, wherein:
comparing includes assigning a normalized term to the selected entry in the first data dictionary when no normalized term has been previously assigned to the selected entry in the first data dictionary; and
assigning includes assigning the normalized term to the entry selected in the second data dictionary.

25. The method of claim 24, further comprising:
creating a mapping file describing the assignments between the entries in the first data dictionary and the entries in the second data dictionary; and
sending the mapping file to the first and second partners.

26. The method of claim 25, further comprising:
receiving a message from one of the first and second partners; and
selectively sending the message to the other of the first and second partners based on the terms of a partner agreement, the terms describing the conditions under which messages may be exchanged between the first and second partners.

27. The method of claim 25, further comprising:
receiving a message from one of the first and second partners, the message requiring concatenation with a further message to produce the equivalent of a message for the other of the first and second partners;
storing the message until the further message is received;
concatenating the message and the further message; and
sending the concatenated message to the other of the first and second partners.

28. The method of claim 24, further comprising:
receiving a message from one of the first and second partners;
translating the message from the protocol of the one of the first and second partners to the protocol of the other of the of the first and second partners based on the assignments between the entries in the first data dictionary and the entries in the second data dictionary; and
sending the translated message to the other of the first and second partners.

29. The method of claim 28, wherein sending comprises:
selectively sending the message based on the terms of a partner agreement, the terms describing the conditions under which messages may be exchanged between the first and second partners.

30. The method of claim 24, further comprising:
receiving a message from one of the first and second partners, the message requiring concatenation with a further message to produce the equivalent of a message for the other of the first and second partners;
storing the message until the further message is received;
concatenating the message and the further message; and
sending the concatenated message to the other of the first and second partners.
